(19) United States
(12) Patent Application Publication
(10) Pub. No.: US 2024/0104351 A1
(43) Pub. Date: Mar. 28, 2024

(54) PREDICTION METHODS AND APPARATUSES FOR ELASTICALLY ADJUSTING COMPUTING POWER

(71) Applicant: Alipay (Hangzhou) Information Technology Co., Ltd., Hangzhou (CN)

(72) Inventors: Jinjie Gu, Hangzhou (CN); Yuze Lang, Hangzhou (CN); Xingyu Lu, Hangzhou (CN); Wenliang Zhong, Hangzhou (CN); Wenqi MA, Hangzhou (CN); Xiaodong Zeng, Hangzhou (CN); Guannan Zhang, Hangzhou (CN)

(73) Assignee: Alipay (Hangzhou) Information Technology Co., Ltd., Hangzhou (CN)

(21) Appl. No.: 18/473,897

(22) Filed: Sep. 25, 2023

(30) Foreign Application Priority Data
Sep. 26, 2022 (CN) 202211173639.0

(51) Int. Cl. G06N 3/045; G06N 3/08

(52) U.S. Cl. CPC G06N 3/045; G06N 3/08

(57) ABSTRACT

Implementations of this specification provide prediction methods and apparatuses for adjusting computing power. One method comprises receiving a prediction request, wherein the prediction request comprises a sample to be tested, determining a computing power coefficient allocated to the prediction request, wherein the computing power coefficient indicates a proportion of hardware computing power resources allocated to the prediction request to total hardware computing power resources needed for a neural network model to run on a computing platform, determining k sub-networks inn sub-networks of the neural network model to be used for a present time based on the computing power coefficient, where n>2, and inputting the sample to be tested to the k sub-networks to obtain a prediction result.

### CROSS-REFERENCE TO RELATED APPLICATIONS

This application claims priority to Chinese Patent Application No. 202211173639.0, filed on Sep. 26, 2022, which is hereby incorporated by reference in its entirety.

### TECHNICAL FIELD

One or more embodiments of this specification relate to the computer field, and in particular, to prediction methods and apparatuses for elastically adjusting computing power.

### BACKGROUND

Currently, a trend of large-scale artificial intelligence (AI) online inference is to use a greener and carbon-cleaner online inference system, referred to as green AI inference. Inference can also be referred to as prediction.

In general AI online inference, computing power consumption of a neural network model used is relatively fixed. However, in green AI inference, computing power consumption of a neural network model used is adjustable. For example, the computing power consumption is dynamically adjusted based on an effect need of online inference. For example, computation with larger computing power is used for requests with rich resources and large contributions to effects, and low computing power is used for requests with strained resources and small contributions to effects. Therefore, the neural network model supports this computing mode of elastic computing power. As attention to privacy data increases, data that training and prediction of the neural network model depend on may be privacy data.

In the existing technology, computing power can be elastically scaled at few levels, and there is little space for elastically adjusting the computing power.

### SUMMARY

One or more embodiments of this specification describe prediction methods and apparatuses for elastically adjusting computing power, so that the computing power can be scaled at many levels, and there is much space for elastically adjusting the computing power.

According to a first aspect, a prediction method for elastically adjusting computing power is provided. The method is performed by using a computing platform. A trained neural network model is deployed on the computing platform, the neural network model includes n sub-networks, and n>2. The method includes the following: a prediction request is received, where the prediction request includes a sample to be tested; a computing power coefficient allocated to the prediction request is determined, where the computing power coefficient indicates a proportion of hardware computing power resources allocated to the prediction request to total hardware computing power resources needed when the neural network model entirely runs on the computing platform; k sub-networks in the n sub-networks to be used this time are determined based on the computing power coefficient; and the sample to be tested is input to the k sub-networks to obtain a prediction result.

In some possible implementations, the neural network model is trained in the following method: the n sub-networks are trained one by one based on a specific order by using a gradient boosting ensemble algorithm and a sample set including a plurality of labeled training samples.

Further, that k sub-networks in the n sub-networks to be used this time are determined includes: first k sub-networks are selected from the n sub-networks based on the order.

Further, that the n sub-networks are trained one by one based on a specific order includes: a first sub-network in the n sub-networks is trained by using the sample set with a target of minimizing a total predicted loss; and any second sub-network after the first sub-network in the n sub-networks is trained by using the sample set in a residual iteration method.

Further, any training sample includes feature values of a sample user corresponding to a plurality of dimension features and a click probability label of the sample user for a target object; and that a first sub-network in the n sub-networks is trained by using the sample set includes: feature values of any sample user corresponding to a plurality of dimension features are input to the first sub-network, and a predicted click probability of the sample user for the target object is output by using the first sub-network; a predicted loss is determined based on a click probability label of the sample user for the target object, the predicted click probability of the sample user for the target object, and a predetermined loss function; and a parameter of the first sub-network is adjusted with a target of minimizing the sum of predicted losses of the sample users in the sample set.

Further, any training sample includes feature values of a sample user corresponding to a plurality of dimension features and a click probability label of the sample user for a target object; and that any second sub-network after the first sub-network in the n sub-networks is trained by using the sample set includes: feature values of any sample user corresponding to a plurality of dimension features are input to each trained sub-network, and a first click probability of the sample user for the target object is output by using each sub-network; a residual is determined based on a click probability label of the sample user for the target object and each first click probability of the sample user for the target object; and a parameter of the second sub-network is adjusted by using the residual as a fitting target.

Further, the target object is any object in a candidate object set.

In some possible implementations, the neural network model is trained in the following method: the n sub-networks are respectively trained based on a mixture of experts (MoE) algorithm by using a sample set including a plurality of labeled training samples, where each sub-network corresponds to an expert network in the MoE algorithm.

Further, that k sub-networks in the n sub-networks to be used this time are determined includes: the k sub-networks are randomly selected from the n sub-networks.

According to a second aspect, a prediction apparatus for elastically adjusting computing power is provided. The apparatus is disposed on a computing platform. A trained neural network model is deployed on the computing platform, the neural network model includes n sub-networks, n>2, and the apparatus includes: a receiving unit, configured to receive a prediction request, where the prediction request includes a sample to be tested; a coefficient determining unit, configured to determine a computing power coefficient allocated to the prediction request received by the receiving unit, where the computing power coefficient indicates a proportion of hardware computing power resources allocated to the prediction request to total hardware computing power resources needed when the neural network model entirely runs on the computing platform; a network determining unit, configured to determine k sub-networks in the n sub-networks to be used this time based on the computing power coefficient determined by the coefficient determining unit; and a prediction unit, configured to input the sample to be tested to the k sub-networks determined by the network determining unit, to obtain a prediction result.

According to a third aspect, a computer-readable storage medium is provided. The computer-readable storage medium stores a computer program, and when the computer program is executed in a computer, the computer is enabled to perform the method of the first aspect.

According to a fourth aspect, a computing device is provided, including a memory and a processor. The memory stores executable code, and when executing the executable code, the processor implements the method of the first aspect.

According to the methods and the apparatuses provided in the embodiments of this specification, the trained neural network model used includes the n sub-networks, and n>2. First, the prediction request is received, where the prediction request includes the sample to be tested; then the computing power coefficient allocated to the prediction request is determined, where the computing power coefficient indicates the proportion of hardware computing power resources allocated to the prediction request to total hardware computing power resources needed when the neural network model entirely runs on the computing platform; then the k sub-networks in the n sub-networks to be used this time are determined based on the computing power coefficient; and finally, the sample to be tested is input to the k sub-networks to obtain the prediction result. It can be seen from the above-mentioned descriptions that in the embodiments of this specification, the n sub-networks are generated through training, and n can be customized. During prediction, only k sub-networks may be dynamically activated as needed, and the value of k can optionally range from 1 to n, so that elastic space for computing power of the neural network model is far greater than that in a conventional solution. Therefore, the computing power can be scaled at many levels, and there is much space for elastically adjusting the computing power.

### BRIEF DESCRIPTION OF DRAWINGS

To describe the technical solutions of the embodiments of this application more clearly, the following briefly describes the accompanying drawings needed for describing the embodiments. Clearly, the accompanying drawings in the following description show merely some embodiments of this application, and a person of ordinary skill in the art can still derive other drawings from these accompanying drawings without creative efforts.

FIG. 1 is a schematic diagram illustrating an implementation scenario, according to one or more embodiments disclosed in this specification;

FIG. 2 is a flowchart illustrating a prediction method for elastically adjusting computing power, according to one or more embodiments;

FIG. 3 is a schematic diagram illustrating a relationship between a prediction result and output results of sub-networks, according to one or more embodiments;

FIG. 4 is a schematic diagram illustrating a relationship between a prediction result and output results of sub-networks, according to one or more other embodiments; and

FIG. 5 is a schematic block diagram illustrating a prediction apparatus for elastically adjusting computing power, according to one or more embodiments.

### DESCRIPTION OF EMBODIMENTS

The solutions provided in this specification are described below with reference to the accompanying drawings.

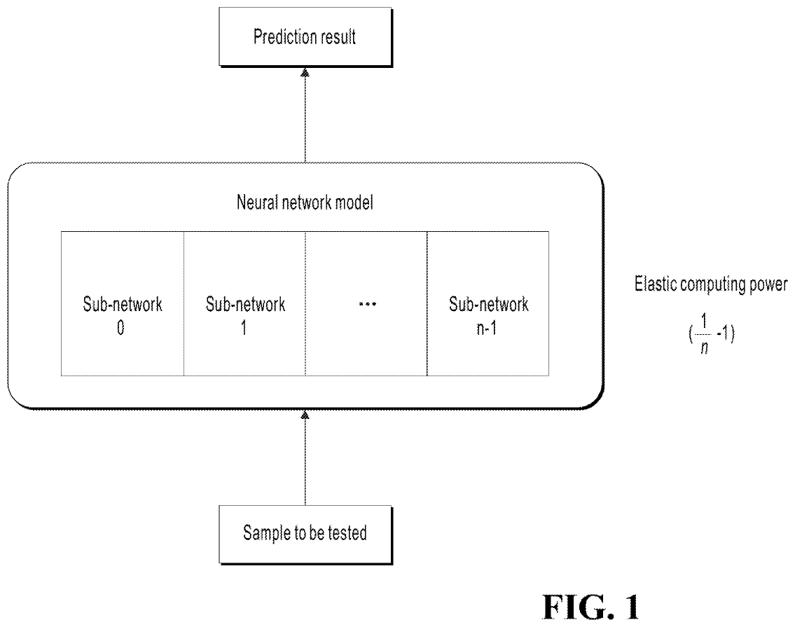

FIG. 1 is a schematic diagram illustrating an implementation scenario, according to one or more embodiments disclosed in this specification. The implementation scenario relates to prediction for elastically adjusting computing power. Referring to FIG. 1, a prediction task is executed by using a computing platform, a trained neural network model is deployed on the computing platform, the neural network model includes n sub-networks, and n>2. For the current prediction task, the n sub-networks can be used, or some of the n sub-networks can be used. It can be understood that when a plurality of sub-networks are used, a prediction result for a sample to be tested can be obtained after output results of the sub-networks used are superimposed. The superimposition can be simply calculating the sum or can be calculating a weighted sum.

In the embodiments of this specification, when the current prediction task is executed, a quantity of sub-networks used determines computing power. When the n sub-networks are used, the computing power is the largest, and in this case, the computing power is denoted as 1. When one sub-network is used, the computing power is the smallest, and in this case, the computing power is denoted as 1/n. When k sub-networks are used, the computing power is denoted as k/n. As such, elastic computing power is implemented by selecting the quantity of sub-networks used.

FLOPS is the acronym of floating-point operations per second. A quantity of FLOPS can be used to measure computing power needed by the neural network model.

For elastic computing power, each time a neural network model performs inference, hardware needs to perform floating-point computation. If the neural network model needs to consume N FLOPS for floating-point computation in one time of prediction, and the value of N can be adjusted from 0 to a maximum value Max through parameter control, it is considered that the neural network model supports elastic computing power.

Referring to FIG. 1, the neural network model includes the n sub-networks. Therefore, elastic computing power supported by the neural network model includes n levels, where n can be customized. The larger the value of n, the more the levels for elastically scaling computing power are, and the greater the space for elastically adjusting the computing power is. For example, when the value of n is 4, there are four levels for elastically scaling the computing power, which are ¼, ½, ¾, and 1. When the value of n is 5, there are five levels for elastically scaling the computing power, which are ⅕, ⅖, ⅗, ⅘, and 1. It can be understood that when n is large enough, it can be considered that the levels for elastically scaling the computing power of the neural network model can be basically consecutive.

In the embodiments of this specification, assume that the sub-networks have equivalent computing power. A structure of each sub-network can be but is not limited to a deep neural network (DNN). In addition to the n sub-networks, the neural network model can include another network structure, for example, a processing unit that superimposes output results of sub-networks used, or a gate unit configured to determine a weight of each sub-network.

The previous prediction task can be prediction tasks in various scenarios, for example, predicting a risk score of a target user in a risk control scenario, or predicting a correlation between a product to be recommended and a target user in a recommendation scenario. The prediction tasks are not listed one by one here.

In the embodiments of this specification, the prediction task can be specifically offline prediction, or can be online prediction. Online prediction is typical, and has a higher requirement for elastic computing power.

The embodiments of this specification can implement green AI online inference. For green artificial intelligence (AI) online inference, resource consumption ROI of AI online inference is much higher than that of a common inference system. ROI=inference effect/inference consumption.

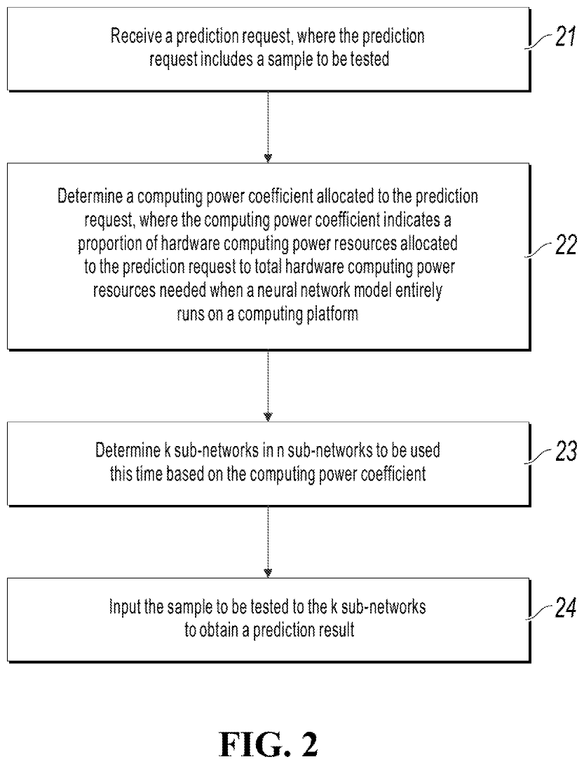

FIG. 2 is a flowchart illustrating a prediction method for elastically adjusting computing power, according to one or more embodiments. The method is performed by using a computing platform, a trained neural network model is deployed on the computing platform, the neural network model includes n sub-networks, and n>2. The method can be on the basis of the implementation scenario shown in FIG. 1. As shown in FIG. 2, the prediction method for elastically adjusting computing power in the embodiments includes the following steps: Step 21: Receive a prediction request, where the prediction request includes a sample to be tested. Step 22: Determine a computing power coefficient allocated to the prediction request, where the computing power coefficient indicates a proportion of hardware computing power resources allocated to the prediction request to total hardware computing power resources needed when the neural network model entirely runs on the computing platform. Step 23: Determine k sub-networks in the n sub-networks to be used this time based on the computing power coefficient. Step 24: Input the sample to be tested to the k sub-networks to obtain a prediction result. The following describes specific methods for performing the above-mentioned steps.

First, in step 21, the prediction request is received, where the prediction request includes the sample to be tested. It can be understood that the sample to be tested can correspond to an organization, a person, an article, etc., and the sample to be tested usually has feature values corresponding to a plurality of dimension features.

In the embodiments of this specification, the prediction request can be considered as a specific prediction task, for example, predicting a risk score of the sample to be tested, or predicting a type of the sample to be tested.

Then, in step 22, the computing power coefficient allocated to the prediction request is determined, where the computing power coefficient indicates the proportion of hardware computing power resources allocated to the prediction request to total hardware computing power resources needed when the neural network model entirely runs on the computing platform. It can be understood that the computing power coefficient can be 50%, 80%, etc.

In the embodiments of this specification, the computing power coefficient allocated to the prediction request can be determined based on at least one of a degree of resource constraint and an effect contribution level of the prediction request. The effect contribution level can correspond to a contribution to a service target, and can be determined based on a feature value of a predetermined feature of the sample to be tested. For example, the sample to be tested is a user to be tested, and the predetermined feature is a member level of the user or a quantity of access times of the user.

In the embodiments of this specification, the hardware computing power resources can be but are not limited to a central processing unit (CPU) processing resource, a memory resource, etc.

Then, in step 23, the k sub-networks in the n sub-networks to be used this time are determined based on the computing power coefficient. It can be understood that k is less than or equal to n.

In the embodiments of this specification, corresponding to a training method for the neural network model, the k sub-networks can be randomly selected from the n sub-networks, or not only a quantity of sub-networks used needs to be k, but also specific k sub-networks need to be specifically selected.

In some examples, the neural network model is trained in the following method: the n sub-networks are trained one by one based on a specific order by using a gradient boosting ensemble algorithm and a sample set including a plurality of labeled training samples.

Further, that k sub-networks in the n sub-networks to be used this time are determined includes: first k sub-networks are selected from the n sub-networks based on the order.

For example, a computing power elasticity coefficient x% needed for this time of calculation is obtained by using a result of evaluating an online calculation effect through green AI. x% represents a computing power level needed this time. The first k sub-networks are dynamically activated to participate in the evaluation, where k=[n*x%]+1. When n is large enough, it can be basically considered that levels of elastic computing power of the model are basically consecutive.

Further, that the n sub-networks are trained one by one based on a specific order includes: a first sub-network in the n sub-networks is trained by using the sample set with a target of minimizing a total predicted loss; and any second sub-network after the first sub-network in the n sub-networks is trained by using the sample set in a residual iteration method.

Further, any training sample includes feature values of a sample user corresponding to a plurality of dimension features and a click probability label of the sample user for a target object; and that a first sub-network in the n sub-networks is trained by using the sample set includes: feature values of any sample user corresponding to a plurality of dimension features are input to the first sub-network, and a predicted click probability of the sample user for the target object is output by using the first sub-network; a predicted loss is determined based on a click probability label of the sample user for the target object, the predicted click probability of the sample user for the target object, and a predetermined loss function; and a parameter of the first sub-network is adjusted with a target of minimizing the sum of predicted losses of the sample users in the sample set.

Further, any training sample includes feature values of a sample user corresponding to a plurality of dimension features and a click probability label of the sample user for a target object; and that any second sub-network after the first sub-network in the n sub-networks is trained by using the sample set includes: feature values of any sample user corresponding to a plurality of dimension features are input to each trained sub-network, and a first click probability of the sample user for the target object is output by using each sub-network; a residual is determined based on a click probability label of the sample user for the target object and each first click probability of the sample user for the target object; and a parameter of the second sub-network is adjusted by using the residual as a fitting target.

For example, the training process roughly includes the following: a parameter is initialized; and the neural network model is recurrently trained for M times, where M is a hyperparameter. To implement full training, the parameter is adjustable. Each time the neural network model is trained, each of the n sub-networks is trained, and the sub-networks (Sub DNN) are numbered 0 to n−1. Assuming that sub-network k is currently trained, training sub-network k includes the following: sub-network k is trained through back propagation by fixing parameters of sub-networks numbered 0 to k−1 and using a residual of y−f(Sub DNN0, . . . , Sub DNN k−1) as a target. It can be understood that y represents a sample label, and f(Sub DNN0, . . . , Sub DNN k−1) represents a prediction result obtained based on first k−1 sub-networks.

Further, the target object is any object in a candidate object set. It can be understood that this example can correspond to the recommendation scenario.

In some other examples, the neural network model is trained in the following method: then sub-networks are respectively trained based on a mixture of experts (MoE) algorithm by using a sample set including a plurality of labeled training samples, where each sub-network corresponds to an expert network in the MoE algorithm.

Further, that k sub-networks in the n sub-networks to be used this time are determined includes: the k sub-networks are randomly selected from the n sub-networks.

In the examples, the sub-networks is trained relatively evenly, and polarization does not occur. In other words, prediction effects of the sub-networks are relatively uniform, and the case that prediction effects of different sub-networks are relatively different does not occur.

Finally, in step 24, the sample to be tested is input to the k sub-networks to obtain the prediction result. It can be understood that the prediction result can be obtained by superimposing output results of the k sub-networks.

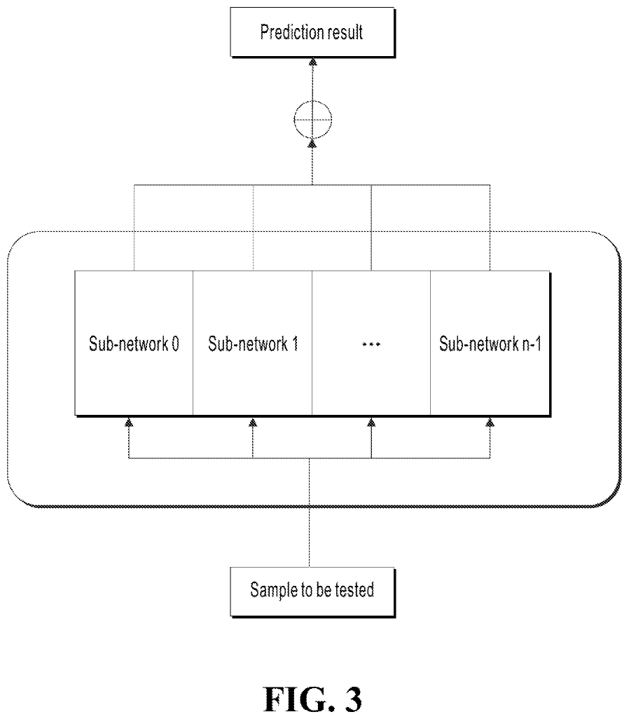

FIG. 3 is a schematic diagram illustrating a relationship between a prediction result and output results of sub-networks, according to one or more embodiments. Referring to FIG. 3, the n sub-networks are trained by using the previously described gradient boosting ensemble algorithm, and the prediction result can be obtained by calculating the sum of the output results of the k sub-networks. For example, if the value of k is 2, the k sub-networks are sub-network 0 and sub-network 1, an output result of sub-network 0 is 0.8, and an output result of sub-network 1 is 0.1, the sum of 0.8 and 0.1 is calculated to obtain a prediction result of 0.9.

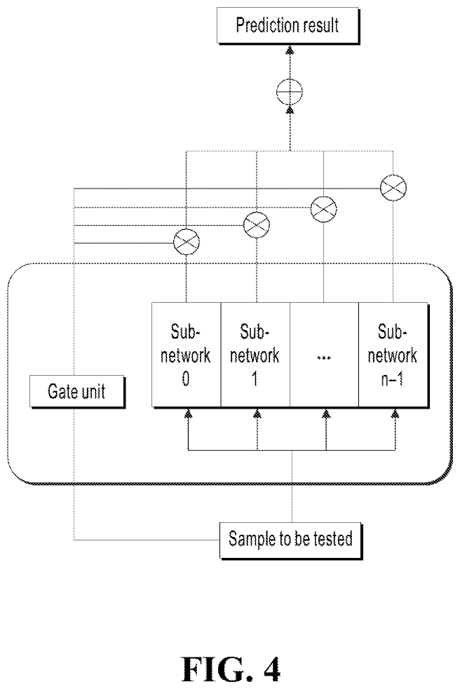

FIG. 4 is a schematic diagram illustrating a relationship between a prediction result and output results of sub-networks, according to one or more other embodiments. Referring to FIG. 4, the n sub-networks are obtained through training by using the previously described MoE algorithm. The prediction result can be obtained by calculating a weighted sum of the output results of the k sub-networks. Weights of the sub-networks are obtained by using a gate unit. If a weight of a sub-network is 0, the sub-network is not used in this time of prediction. For example, if the value of k is 2, the k sub-networks are sub-network 0 and sub-network n−1, an output result of sub-network 0 is 0.8, a weight of sub-network 0 is a, an output result of sub-network n−1 is 0.1, and a weight of sub-network n-1 is b, a weighted sum of output results of the two sub-networks is calculated, that is, 0.8*a+0.1*b is calculated, to obtain a prediction result of 0.8 a+0.1 b.

According to the methods provided in the embodiments of this specification, the trained neural network model used includes the n sub-networks, and n>2. First, the prediction request is received, where the prediction request includes the sample to be tested; then the computing power coefficient allocated to the prediction request is determined, where the computing power coefficient indicates the proportion of hardware computing power resources allocated to the prediction request to total hardware computing power resources needed when the neural network model entirely runs on the computing platform; then the k sub-networks in the n sub-networks to be used this time are determined based on the computing power coefficient; and finally, the sample to be tested is input to the k sub-networks to obtain the prediction result. It can be seen from the above-mentioned descriptions that in the embodiments of this specification, the n sub-networks are generated through training, and n can be customized. During prediction, only k sub-networks may be dynamically activated as needed, and the value of k can optionally range from 1 to n, so that elastic space for computing power of the neural network model is far greater than that in a conventional solution. Therefore, the computing power can be scaled at many levels, and there is much space for elastically adjusting the computing power.

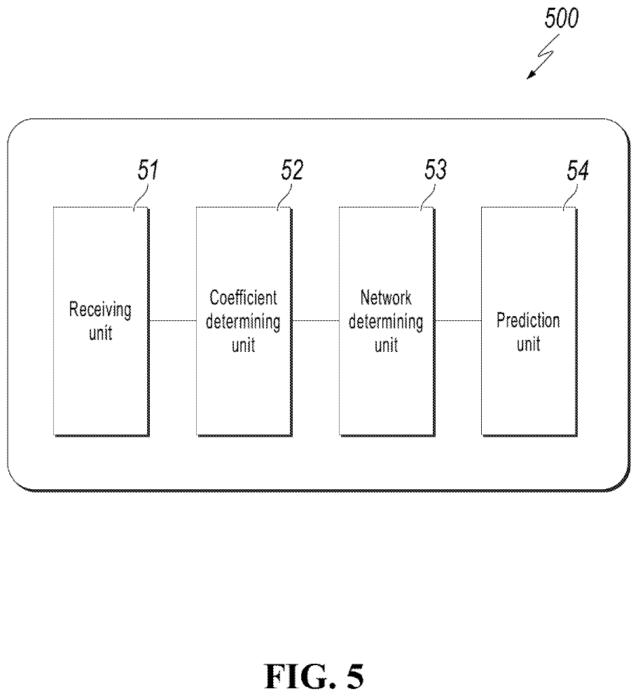

According to embodiments of another aspect, a prediction apparatus for elastically adjusting computing power is provided. The apparatus is disposed on a computing platform. A trained neural network model is deployed on the computing platform, the neural network model includes n sub-networks, n>2, and the apparatus is configured to perform the method provided in the embodiments of this specification. FIG. 5 is a schematic block diagram illustrating a prediction apparatus for elastically adjusting computing power, according to one or more embodiments. As shown in FIG. 5, the apparatus 500 includes: a receiving unit 51, configured to receive a prediction request, where the prediction request includes a sample to be tested; a coefficient determining unit 52, configured to determine a computing power coefficient allocated to the prediction request received by the receiving unit 51, where the computing power coefficient indicates a proportion of hardware computing power resources allocated to the prediction request to total hardware computing power resources needed when the neural network model entirely runs on the computing platform; a network determining unit 53, configured to determine k sub-networks in the n sub-networks to be used this time based on the computing power coefficient determined by the coefficient determining unit 52; and a prediction unit 54, configured to input the sample to be tested to the k sub-networks determined by the network determining unit 53, to obtain a prediction result.

Optionally, in some embodiments, the neural network model is trained in the following method: the n sub-networks are trained one by one based on a specific order by using a gradient boosting ensemble algorithm and a sample set including a plurality of labeled training samples.

Further, the network determining unit 53 is specifically configured to select first k sub-networks from the n sub-networks based on the order.

Further, that the n sub-networks are trained one by one based on a specific order includes: a first sub-network in the n sub-networks is trained by using the sample set with a target of minimizing a total predicted loss; and any second sub-network after the first sub-network in the n sub-networks is trained by using the sample set in a residual iteration method.

Further, any training sample includes feature values of a sample user corresponding to a plurality of dimension features and a click probability label of the sample user for a target object; and that a first sub-network in the n sub-networks is trained by using the sample set includes: feature values of any sample user corresponding to a plurality of dimension features are input to the first sub-network, and a predicted click probability of the sample user for the target object is output by using the first sub-network; a predicted loss is determined based on a click probability label of the sample user for the target object, the predicted click probability of the sample user for the target object, and a predetermined loss function; and a parameter of the first sub-network is adjusted with a target of minimizing the sum of predicted losses of the sample users in the sample set.

Further, any training sample includes feature values of a sample user corresponding to a plurality of dimension features and a click probability label of the sample user for a target object; and that any second sub-network after the first sub-network in the n sub-networks is trained by using the sample set includes: feature values of any sample user corresponding to a plurality of dimension features are input to each trained sub-network, and a first click probability of the sample user for the target object is output by using each sub-network; a residual is determined based on a click probability label of the sample user for the target object and each first click probability of the sample user for the target object; and a parameter of the second sub-network is adjusted by using the residual as a fitting target.

Further, the target object is any object in a candidate object set.

Optionally, in some embodiments, the neural network model is trained in the following method: respectively training the n sub-networks based on a mixture of experts (MoE) algorithm by using a sample set including a plurality of labeled training samples, where each sub-network corresponds to an expert network in the MoE algorithm.

Further, that k sub-networks in the n sub-networks to be used this time are determined includes: the k sub-networks are randomly selected from the n sub-networks.

According to the apparatus provided in the embodiments of this specification, the trained neural network model used includes the n sub-networks, and n>2. First, the receiving unit 51 receives the prediction request, where the prediction request includes the sample to be tested; then the coefficient determining unit 52 determines the computing power coefficient allocated to the prediction request, where the computing power coefficient indicates the proportion of hardware computing power resources allocated to the prediction request to total hardware computing power resources needed when the neural network model entirely runs on the computing platform; then the network determining unit 53 determines the k sub-networks in the n sub-networks to be used this time based on the computing power coefficient; and finally, the prediction unit 54 inputs the sample to be tested to the k sub-networks to obtain the prediction result. It can be seen from the above-mentioned descriptions that in the embodiments of this specification, the n sub-networks are generated through training, and n can be customized. During prediction, only k sub-networks may be dynamically activated as needed, and the value of k can optionally range from 1 to n, so that elastic space for computing power of the neural network model is far greater than that in a conventional solution. Therefore, the computing power can be scaled at many levels, and there is much space for elastically adjusting the computing power.

According to one or more embodiments of another aspect, a computer-readable storage medium is further provided. The computer-readable storage medium stores a computer program, and when the computer program is executed in a computer, the computer is enabled to perform the method described with reference to FIG. 2.

According to one or more embodiments of still another aspect, a computing device is further provided, including a memory and a processor. The memory stores executable code, and when executing the executable code, the processor implements the method described with reference to FIG. 2.

A person skilled in the art should be aware that, in the one or more examples described above, functions described in this application can be implemented by hardware, software, firmware, or any combination thereof. When this application is implemented by the software, the functions can be stored in a computer-readable medium or transmitted as one or more instructions or code in a computer-readable medium.

The specific implementations mentioned above provide further detailed explanations of the objectives, technical solutions, and beneficial effects of this application. It should be understood that the above-mentioned descriptions are merely specific implementations of this application and are not intended to limit the protection scope of this application. Any modifications, equivalent replacements, improvements, etc. made on the basis of the technical solutions of this application should all fall within the protection scope of this application.

1. A computer-implemented method for adjusting computing power, comprising:
receiving a prediction request, wherein the prediction request comprises a sample to be tested;
determining a computing power coefficient allocated to the prediction request, wherein the computing power coefficient indicates a proportion of hardware computing power resources allocated to the prediction request to total hardware computing power resources needed for a neural network model to run on a computing platform;
determining k sub-networks in n sub-networks of the neural network model to be used for a present time based on the computing power coefficient, where n>2; and
inputting the sample to be tested to the k sub-networks to obtain a prediction result.

2. The method according to claim 1, wherein the neural network model is trained based on:
training the n sub-networks one by one based on a predetermined order by using a gradient boosting ensemble algorithm and a sample set that comprises a plurality of labeled training samples.

3. The method according to claim 2, wherein determining the k sub-networks comprises:
selecting first k sub-networks from the n sub-networks based on the predetermined order.

4. The method according to claim 2, wherein training the n sub-networks one by one based on the predetermined order comprises:
training a first sub-network in the n sub-networks by using the sample set to minimize a total predicted loss; and
training a second sub-network after the first sub-network in the n sub-networks by using the sample set in a residual iteration method.

5. The method according to claim 4, wherein the plurality of labeled training samples each comprises feature values of a sample user corresponding to a plurality of dimension features and a click probability label of the sample user for a target object; and
training the first sub-network in the n sub-networks comprises:
inputting feature values of a sample user corresponding to a plurality of dimension features to the first sub-network;
outputting a predicted click probability of the sample user for the target object by using the first sub-network;
determining a predicted loss based on a click probability label of the sample user for the target object, the predicted click probability of the sample user for the target object, and a predetermined loss function; and
adjusting a parameter of the first sub-network to minimize a sum of predicted losses of the sample users in the sample set.

6. The method according to claim 4, wherein the plurality of labeled training samples each comprises feature values of a sample user corresponding to a plurality of dimension features and a click probability label of the sample user for a target object; and
training the second sub-network after the first sub-network comprises:
inputting feature values of a sample user corresponding to a plurality of dimension features to each trained sub-network;
outputting a first click probability of the sample user for the target object by using each sub-network;
determining a residual based on a click probability label of the sample user for the target object and each first click probability of the sample user for the target object; and
adjusting a parameter of the second sub-network by using the residual as a fitting target.

7. The method according to claim 5, wherein the target object is an object in a candidate object set.

8. The method according to claim 1, wherein the neural network model is trained based on:
training the n sub-networks based on a mixture of experts (MoE) algorithm by using a sample set comprising a plurality of labeled training samples, wherein each sub-network corresponds to an expert network in the MoE algorithm.

9. The method according to claim 8, wherein determining k sub-networks in the n sub-networks to be used for the present time comprises:
randomly selecting the k sub-networks from the n sub-networks.

10. A non-transitory, computer-readable medium storing one or more instructions executable by a computer system to perform operations comprising:
receiving a prediction request, wherein the prediction request comprises a sample to be tested;
determining a computing power coefficient allocated to the prediction request, wherein the computing power coefficient indicates a proportion of hardware computing power resources allocated to the prediction request to total hardware computing power resources needed for a neural network model to run on a computing platform;
determining k sub-networks in n sub-networks of the neural network model to be used for a present time based on the computing power coefficient, where n>2; and
inputting the sample to be tested to the k sub-networks to obtain a prediction result.

11. The non-transitory, computer-readable medium according to claim 10, wherein the neural network model is trained based on:
training the n sub-networks one by one based on a predetermined order by using a gradient boosting ensemble algorithm and a sample set that comprises a plurality of labeled training samples.

12. The non-transitory, computer-readable medium according to claim 11, wherein determining the k sub-networks comprises:
selecting first k sub-networks from the n sub-networks based on the predetermined order.

13. The non-transitory, computer-readable medium according to claim 11, wherein training the n sub-networks one by one based on the predetermined order comprises:
training a first sub-network in the n sub-networks by using the sample set to minimize a total predicted loss; and
training a second sub-network after the first sub-network in the n sub-networks by using the sample set in a residual iteration method.

14. The non-transitory, computer-readable medium according to claim 13, wherein the plurality of labeled training samples each comprises feature values of a sample user corresponding to a plurality of dimension features and a click probability label of the sample user for a target object; and
training the first sub-network in the n sub-networks comprises:
inputting feature values of a sample user corresponding to a plurality of dimension features to the first sub-network;
outputting a predicted click probability of the sample user for the target object by using the first sub-network;
determining a predicted loss based on a click probability label of the sample user for the target object, the predicted click probability of the sample user for the target object, and a predetermined loss function; and
adjusting a parameter of the first sub-network to minimize a sum of predicted losses of the sample users in the sample set.

15. The non-transitory, computer-readable medium according to claim 13, wherein the plurality of labeled training samples each comprises feature values of a sample user corresponding to a plurality of dimension features and a click probability label of the sample user for a target object; and
training the second sub-network after the first sub-network comprises:
inputting feature values of a sample user corresponding to a plurality of dimension features to each trained sub-network;
outputting a first click probability of the sample user for the target object by using each sub-network;
determining a residual based on a click probability label of the sample user for the target object and each first click probability of the sample user for the target object; and
adjusting a parameter of the second sub-network by using the residual as a fitting target.

16. The non-transitory, computer-readable medium according to claim 14, wherein the target object is an object in a candidate object set.

17. The non-transitory, computer-readable medium according to claim 10, wherein the neural network model is trained based on:
training the n sub-networks based on a mixture of experts (MoE) algorithm by using a sample set comprising a plurality of labeled training samples, wherein each sub-network corresponds to an expert network in the MoE algorithm.

18. The non-transitory, computer-readable medium according to claim 17, wherein determining k sub-networks in the n sub-networks to be used for the present time comprises:
randomly selecting the k sub-networks from the n sub-networks.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a prediction request, wherein the prediction request comprises a sample to be tested;
determining a computing power coefficient allocated to the prediction request, wherein the computing power coefficient indicates a proportion of hardware computing power resources allocated to the prediction request to total hardware computing power resources needed for a neural network model to run on a computing platform;
determining k sub-networks in n sub-networks of the neural network model to be used for a present time based on the computing power coefficient, where n>2; and
inputting the sample to be tested to the k sub-networks to obtain a prediction result.

20. The computer-implemented system according to claim 19, wherein the neural network model is trained based on:
training the n sub-networks one by one based on a predetermined order by using a gradient boosting ensemble algorithm and a sample set that comprises a plurality of labeled training samples.
